(19) United States
(12) Patent Application Publication
(10) Pub. No.: US 2005/0219129 A1
(43) Pub. Date: Oct. 6, 2005

(54) Radio communication terminal

(75) Inventor: Nobuya Harano, Kakegawa-shi (JP)

Correspondence Address: YOUNG & THOMPSON, 745 SOUTH 23RD STREET, 2ND FLOOR, ARLINGTON, VA, 22202, US

(73) Assignee: NEC ACCESS TECHNICA, LTD., KAKEGAWA-SHI (JP)

(21) Appl. No.: 11/092,707

(22) Filed: Mar. 30, 2005

(30) Foreign Application Priority Data
Mar. 30, 2004 (JP) 100736/2004

(51) Int. Cl. H01Q 1/24

(52) U.S. Cl. 343/702; 343/725

(57) ABSTRACT

A rectangular substrate provided in a radio communication terminal includes a built-in antenna and a grounded conductor functioning as a current control conductor. The antenna is placed in the vicinity of one short side of the substrate, and the current control conductor is placed in a vicinity of the other short side of the substrate. When the substrate has, for example, a half wavelength, the current control conductor changes an effective length of the substrate to reduce a high-frequency induced current generated in the substrate. Therefore, the deterioration of the antenna characteristics influenced by the human body can be prevented. The invention is applicable to the radio communication terminal having two casings movably connected by a connector.

### BACKGROUND OF THE INVENTION

1. Field of the Invention

The present invention relates to a radio communication terminal, and more particularly to a radio communication terminal capable of maintaining preferable antenna characteristics even during a call.

2. Description of the Related Art

Recently, many small radio communication terminals have their antennas built in the casing thereof. Various types of antennas are known as antennas built in the casing. With the use of resonant antennas such as microstrip-type antennas, at the time of radio wave emission, a high-frequency induced current (that is, image current) flowing in an electrically conductive portion (particularly, a substrate portion) within the terminals based on high-frequency induction is small. Therefore, when this type of antenna is built in the casing of a radio communication terminal, there arises no problem influencing a call. On the other hand, with the use of open-type antennas such as inverse L-type antennas, inverse F-type antennas, and helical antennas, a large image current flows in the substrate portion at the time of radio wave emission.

FIGS. 1A and 1B show an example of usage of a radio communication terminal (for example, a mobile telephone). When the user of a mobile telephone 20 makes a call, the user brings a speaker in a receiver section of the mobile telephone 20 to his/her ear. At this time, the head 10 of the user is close to a substantially central portion 30 of the mobile telephone 20, which influences the transmission and reception of radio waves to and from the mobile telephone 20. Recently most mobile telephones have a casing length of 10 to 15 cm. The frequency of radio waves used for the mobile telephones is about 1 GHz, and the wavelength thereof is approximately 30 cm. Therefore, the half-wavelength of the radio waves is approximately 15 cm, which is nearly equal to the length of the long side of a substrate built in the mobile telephone. Accordingly, resonance occurs in the substrate where vicinities of the short sides of the substrate serve as nodes and a central portion of the substrate in the longitudinal direction serves as a loop, so a large image current flows particularly in the vicinity of the loop. As the central portion 30, in which a large image current flows, of the mobile telephone approaches the head 10 of the user, a high-frequency electromagnetic field distribution in the mobile telephone is disturbed and the transmission/reception characteristics of the open-type antennas significantly deteriorates.

Various types of radio communication terminals have been proposed in order to solve the above-described problem. Of such radio communication terminals, a mobile radio device including a multi-resonant antenna has two current control conductors each having the quarter wavelengths corresponding to a first frequency and a second frequency and provides optimum antenna characteristics. JP 2003-198410 A discloses a communication terminal having an antenna element and a current control conductor disposed near the antenna. The current control conductor has both ends that are open and resonates at a used frequency. In this communication terminal, since radiation from the current control conductor is dominant compared with radiation from a circuit board, an antenna current on the circuit board is suppressed. Therefore, even when the communication terminal is brought close to a human body, an antenna gain is not largely reduced. JP 3296189 B discloses an inverted F-type, quarter-wavelength antenna disposed over an electrically conductive plate and a non-driven, quarter-wavelength element disposed substantially in parallel to the inverted F-type antenna. With this structure, a multi-resonant impedance characteristic is obtained. JP 2003-037413 A discloses a communication terminal having an antenna element and a current control conductor operating as a reflector, and having the antenna directivity in the direction opposite to the human body. Accordingly, a reduction in the antenna gain during a call is prevented.

However, in the known communication terminals described above, the antenna element and the current control conductor are disposed relatively close to each other. Therefore, the antenna directivities of these communication terminals largely vary. In JP 2003-037413 A, the current control conductor is intentionally used to change the antenna directivity, but an influence exerted by the image current is not mentioned at all in the publication.

### SUMMARY OF THE INVENTION

In one aspect of the invention, a radio communication terminal includes a rectangular substrate, an antenna section, and a current control conductor. The rectangular substrate is disposed in a casing of the terminal. The antenna section is disposed in a vicinity of one short side of the substrate. The current control conductor is disposed and grounded in a vicinity of the other short side of the substrate.

In another aspect of the invention, a radio communication terminal includes two casings connected by a connector. The terminal includes an antenna section disposed in a vicinity of the connector of a casing and a current control conductor disposed and grounded in the direction opposite to the antenna section on the casing.

The radio communication terminal may include a plurality of current control conductors. The current control conductor may include a meander-shaped portion or a helical-shaped portion. In the radio communication terminal, an effective length of the substrate significantly varies due to the current control conductor. Therefore, the occurrence of resonance of a high-frequency induced current in the substrate can be suppressed, thereby significantly reducing an image current flowing in a central portion of the substrate. As a result, the antenna characteristics are not influenced by a human body even during a call.

### BRIEF DESCRIPTION OF THE DRAWINGS

The above and other objects, features and advantages of the present invention will become apparent from the following detailed description when taken with the accompanying drawings in which:

FIGS. 1A and 1B show an example of usage of a radio communication terminal according to the present invention;

FIG. 2 shows an example of a substrate built in the radio communication terminal according to the present invention;

FIG. 3 shows an example of distribution of an image current on the substrate;

FIGS. 4-10 show examples of the substrates built in the radio communication terminals according to the present invention;

FIG. 11 shows another example of distribution of an image current in the radio communication terminal;

FIGS. 12-17 show examples of arrangement of the antenna section and the current control conductor in/on the radio communication terminal.

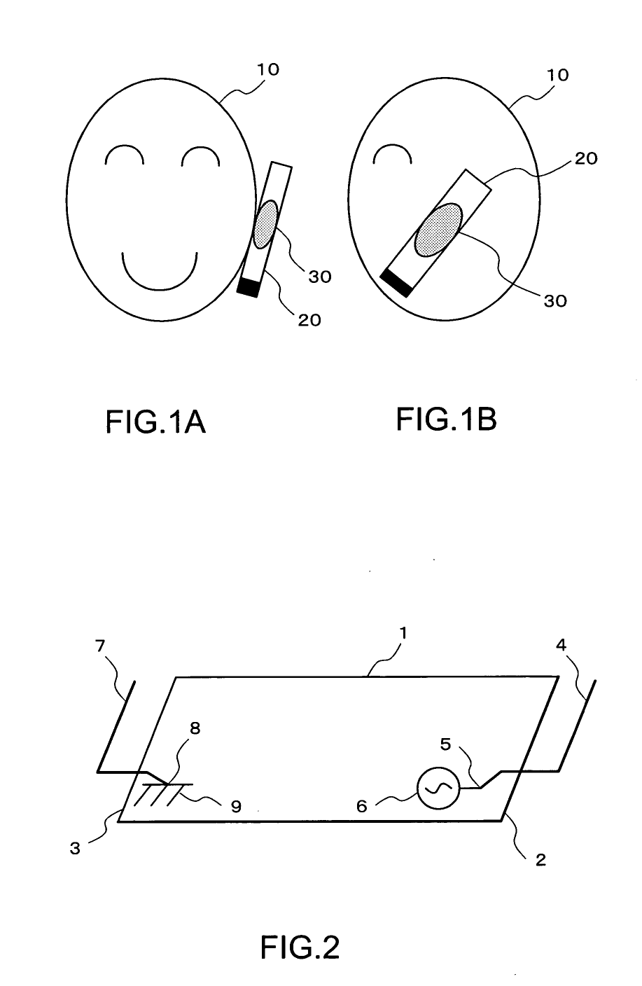

### DETAILED DESCRIPTION OF THE PREFERRED EMBODIMENTS

Hereinafter, preferred embodiments of the present invention will be described. Referring to FIG. 2, a substrate 1 built in a radio communication terminal according to an embodiment of the present invention includes a built-in antenna 4, a contact terminal 5, and a radio section 6 which are disposed near one short side 2 of the substrate 1. The substrate 1 also includes a current control conductor 7, a contact terminal 8, and a ground section 9 which are disposed near the other short side 3 of the substrate 1. The substrate 1 further includes an electronic circuit necessary for operations of the radio communication terminal. The antenna 4 is an L-shaped linear conductor disposed in parallel to the substrate 1. The linear conductor is formed on an inner surface of the casing of the radio communication terminal and connected to the radio section 6 via the contact terminal 5. The current control conductor 7 is an L-shaped linear conductor disposed substantially in parallel to the substrate 1. The current control conductor 7 is also formed on the inner surface of the casing, in the same way as the antenna 4. One end of the current control conductor 7 is grounded to the ground section 9 via the contact terminal 8.

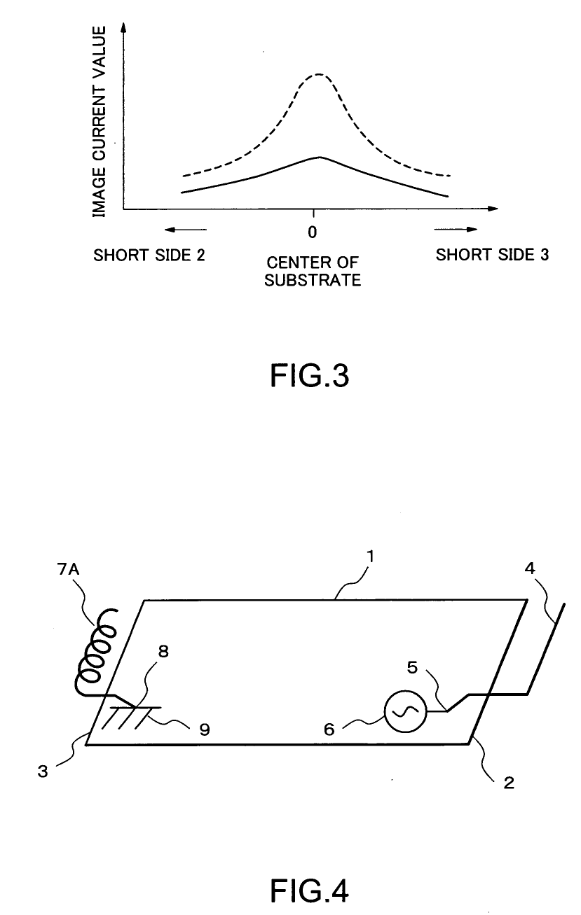

An operation example of the antenna 4 will be described below. When the radio section 6 supplies power to the antenna 4 via the contact terminal 5, a current flows in the antenna 4. At the same time, a high-frequency induced current (image current) flows in the substrate 1 in the casing. When an effective length of the substrate 1 is equal to or close to the half wavelength of the used frequency, the resonance described above occurs. At this time, the value of the high-frequency induced current (image current) in the substrate 1 is small in the vicinity of the short sides 2 and 3 of the substrate 1 and large in the central portion of the substrate 1, as indicated by a curve (a dashed line) in the graph of FIG. 3. However, when the current control conductor 7 is formed in the substrate 1, the effective length of the substrate 1 becomes long (that is, an intrinsic resonance frequency becomes low). As a result, as indicated by a curve (a solid line) shown in FIG. 3, the distribution of the image current varies and the image current flowing in the central portion of the substrate 1 decreases. When the user makes a call, the central portion of the casing of the radio communication terminal is brought close to the head of the user. At this time, the value of the image current flowing in the central portion of the substrate 1 is small, so the electromagnetic wave loss is small and the antenna characteristics hardly deteriorate.

FIG. 4 shows another example of the substrate 1 of the radio communication terminal. The plural components disposed on the substrate 1 and the positions thereof are the same as those of the example shown in FIG. 2. In this example, however, a current control conductor 7A has a helical-shaped portion. The center axis of the helical-shaped portion is placed substantially in parallel to a surface of the substrate 1. The helical-shaped portion of the current control conductor 7A and the antenna 4 are installed on the inner surface of the casing. The current control conductor 7A having the helical-shaped portion allows the effective length of the substrate 1 to be longer than that of the linear current control conductor 7 shown in FIG. 2. Therefore, the current control conductor 7A having the helical-shaped portion is applicable to radio communication terminals using lower frequencies. Further, the current control conductor 7A having the helical-shaped portion described above can be mounted within a small space in the casing.

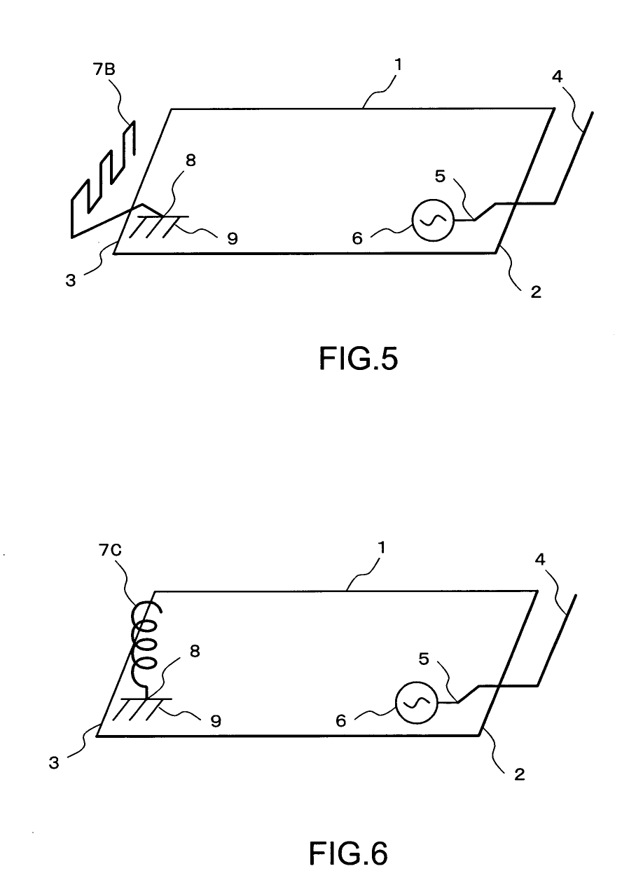

FIG. 5 shows still another example of the substrate 1 of the radio communication terminal. The plural components disposed on the substrate 1 and the positions thereof are the same as those shown in FIG. 2. In this example, however, a current control conductor 7B has a meander-shaped portion. The meander-shaped portion is disposed substantially in parallel to the surface of the substrate 1. The current control conductor 7B and the antenna 4 are formed on the inner surface of the casing. The current control conductor 7B having the meander-shaped portion allows the effective length of the substrate 1 to be longer in the same way as the current control conductor 7A described above. Therefore, the image current value in the central portion of the substrate 1 is reduced.

FIG. 6 shows still another example of the substrate 1 of the radio communication terminal. The plural components disposed on the substrate 1 and the positions thereof are the same as those shown in FIG. 2. In this example, however, a current control conductor 7C has a helical-shaped portion. The helical-shaped portion of the current control conductor 7C is disposed substantially perpendicular to the substrate 1. The current control conductor 7C also reduces the image current value in the central portion of the substrate 1 in the same way as the current control conductor 7A shown in FIG. 4, and prevents the deterioration of the antenna characteristics.

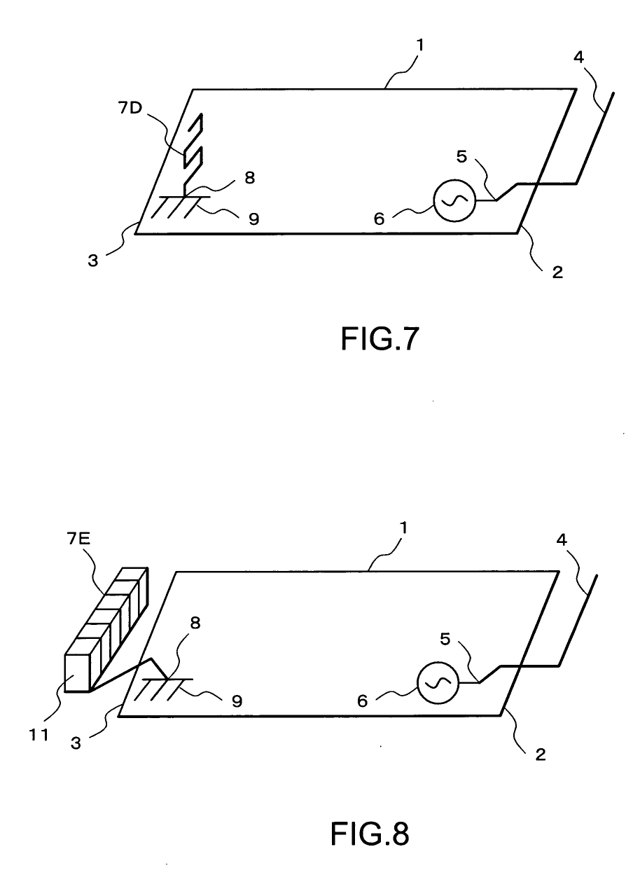

FIG. 7 shows still another example of the substrate 1 of the radio communication terminal. The plural components disposed on the substrate 1 are the same as those shown in FIG. 2. In this example, however, a current control conductor 7D has a meander-shaped portion. The meander-shaped portion is formed substantially perpendicular to the surface of the substrate 1. The current control conductor 7D also has the effect of preventing the deterioration of the antenna characteristics, as described above.

FIG. 8 shows still another example of the substrate 1 of the radio communication terminal. The components disposed on the substrate 1 are the same as those shown in FIG. 2. In this example, however, a current control conductor 7E has a helical-shaped portion. The helical-shaped portion is formed so as to be brought into intimate contact with surfaces of an insulator bar 11. The insulator bar 11 is disposed substantially in parallel to the surface of the substrate 1. The insulator has a dielectric constant of 3 to 10, for example. The insulator bar 11 can have a circular, square, or other shape in cross section. The current control conductor 7E also has the effect of preventing the deterioration of the antenna characteristics as described above.

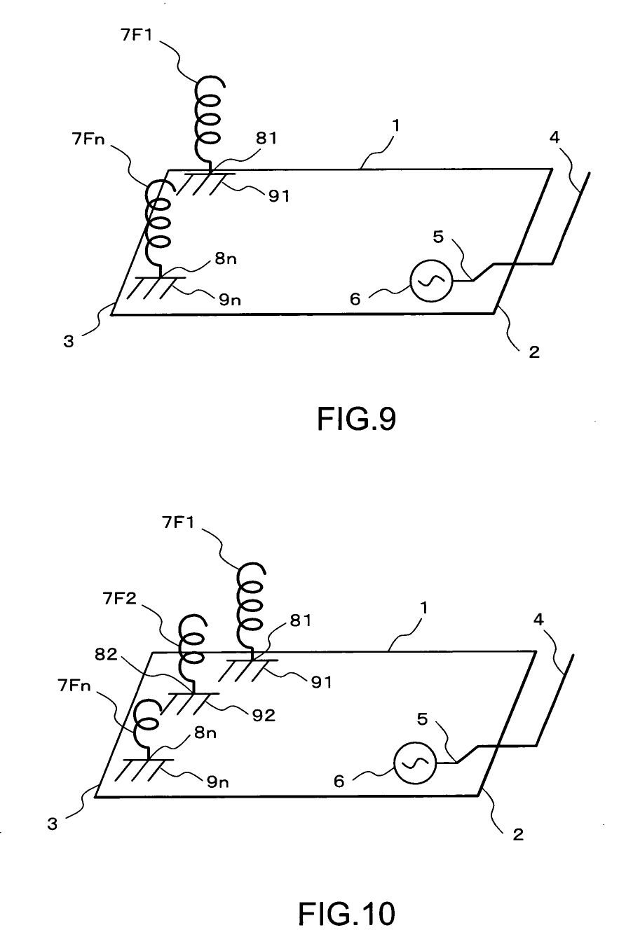

FIG. 9 shows still another example of the substrate 1 of the radio communication terminal. In this example, n (n is an integer equal to 2 or more) current control conductors 7F1 to 7Fn having a helical-shaped portion are disposed near the short side 3 of the substrate 1. The current control conductors 7F1 to 7Fn are connected to ground sections 91 to 9n via contact terminals 81 to 8n, respectively. The helical-shaped portions of the current control conductors 7F1 to 7Fn are disposed substantially perpendicular to the surface of the substrate 1. The current control conductors 7F1 to 7Fn can be current control conductors all having meander-shaped portions. Alternatively, a current control conductor having a helical-shaped portion and a current control conductor having a meander-shaped portion can be disposed together.

FIG. 10 shows still another example of the substrate 1 of the radio communication terminal. Similar to the example shown in FIG. 9, the substrate 1 has the n (n is an integer equal to 2 or more) current control conductors 7F1 to 7Fn each having a helical-shaped portion which are disposed near the short side 3 of the substrate 1. The current control conductors 7F1 to 7Fn in this example are respectively connected to the ground sections 91, 92, . . . , and 9n, and form effective lengths (intrinsic resonance frequencies) different from each other to adjust the image current distribution on the substrate 1. Therefore, it is possible to efficiently prevent the deterioration of the antenna characteristics during a call. In the example shown in FIG. 10, a current control conductor having a meander-shaped portion can be also used. Further, the above-mentioned two types of the current control conductors can be disposed together. In the examples shown in FIGS. 9 and 10, a plurality of current control conductors can be disposed on both surfaces of the substrate 1.

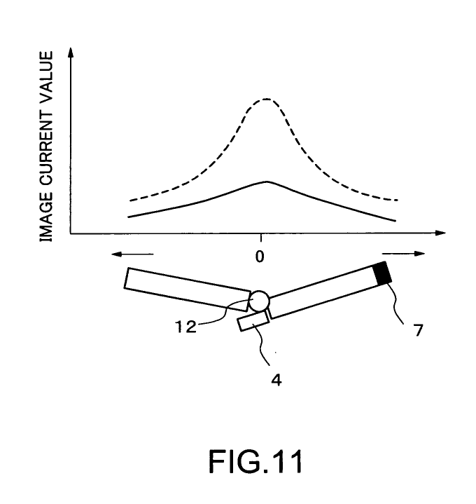

Hereinafter, another embodiment of the present invention will be described. A radio communication terminal includes two casings foldably or slidably connected by a connector 12. In one casing, an antenna section is disposed in a vicinity of the connector 12. In the same casing, a current control conductor is disposed in the direction opposite to the antenna section. One end of the conductor is grounded. Referring to FIG. 11, the value of the high-frequency induced current (i.e. image current) in the casing is small in the vicinity of the ends of the radio communication terminal and large in the central portion of the terminal, as indicated by a curve (a dashed line) in the graph of FIG. 11. However, when the current control conductor 7 is formed in the end of the terminal, the effective length of the terminal becomes long (that is, an intrinsic resonance frequency becomes low). As a result, as indicated by a curve (a solid line) shown in FIG. 11, the distribution of the image current varies and the image current flowing in the central portion of the terminal decreases.

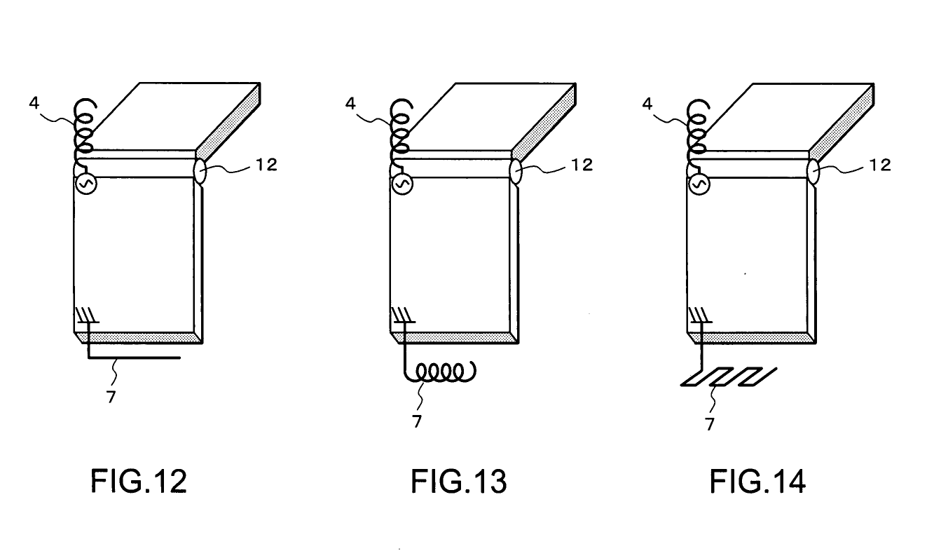

FIG. 12 shows an antenna section 4 which is disposed in the vicinity of the connector 12. The antenna section 4 can be disposed out of the casing. The current control conductor 7 is located in the opposite direction to the antenna section 4.

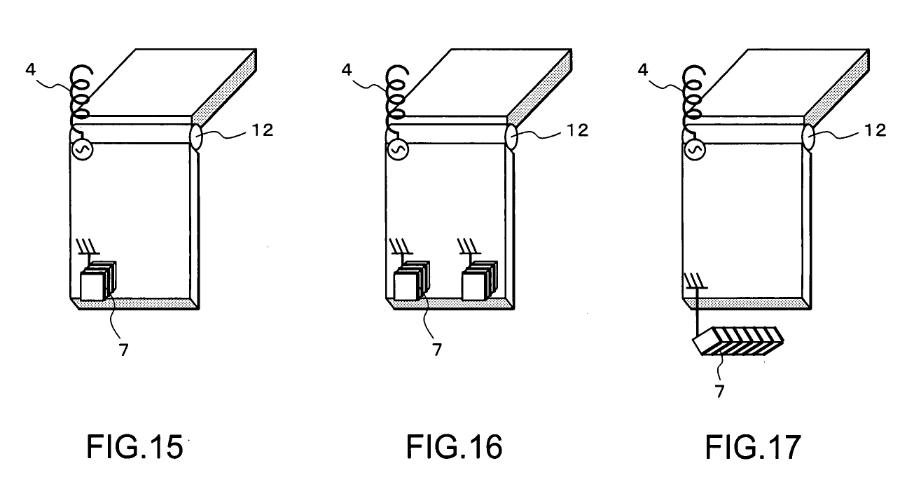

FIG. 13 shows an example of the current control conductor 7 having a helical-shaped portion. FIG. 14 shows an example of the current control conductor 7 having a meander-shaped portion. FIG. 15 shows the current control conductor 7 including a helical-shaped portion which is formed on a surface of an insulator bar. The insulator bar is disposed in a direction perpendicular to a casing surface or to a substrate in the casing. In an example shown in FIG. 16, the terminal includes a plurality of the conductors 7 each having an insulator. FIG. 17 shows the conductor 7 having the insulator which is disposed parallel to the casing surface or to the substrate in the casing. In the examples shown in FIGS. 11-17, the current control conductors 7 can be disposed on the casing surface or in the casing. Each end of the conductors 7 is grounded.

The present invention is not limited to the case where the effective length of the substrate or the casings is substantially a half wavelength of the intrinsic resonance frequency, but the present invention can also be effectively applied to a case where the substrate or the casings has an effective length larger than the half wave length of the intrinsic resonance frequency. In the case where a plurality of current control conductors are disposed, the respective helical-shaped portions or the meander-shaped portions of the current control conductors can be different from each other in their diameters, widths, pitches, etc. The diameter, width, pitch, etc. of the helical-shaped portion or the meander-shaped portion may also be varied within one current control conductor. Further, one current control conductor can have both of a helical-shaped portion and a meander-shaped portion.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

Further, it is the inventor's intent to refrain all equivalents of the claimed invention even if the claims are amended during prosecution.

1. A radio communication terminal comprising:
a rectangular substrate disposed in a casing of the radio communication terminal;
an antenna section disposed in a vicinity of one short side of the rectangular substrate; and
a current control conductor disposed and grounded in a vicinity of the other short side of the rectangular substrate.

2. A radio communication terminal according to claim 1, wherein the current control conductor is disposed substantially in parallel to the rectangular substrate.

3. A radio communication terminal according to claim 1, wherein the current control conductor comprises a meander-shaped portion.

4. A radio communication terminal according to claim 1, wherein the current control conductor comprises a helical-shaped portion.

5. A radio communication terminal according to claim 4, wherein the helical-shaped portion is formed on a surface of an insulator.

6. A radio communication terminal according to claim 1, wherein the current control conductor comprises a portion disposed substantially perpendicular to the rectangular substrate.

7. A radio communication terminal according to claim 6, wherein the portion disposed substantially perpendicular to the substrate comprises a meander shape.

8. A radio communication terminal according to claim 6, wherein the portion disposed substantially perpendicular to the substrate comprises a helical shape.

9. A radio communication terminal according to claim 6, wherein a plurality of current control conductors are disposed.

10. A radio communication terminal according to claim 9, wherein the plurality of current control conductors change an effective length of a long side of the substrate to lengths different from each other.

11. A radio communication terminal according to claim 1, wherein the current control conductor is disposed on an inner surface of a casing of the radio communication terminal.

12. A radio communication terminal according to claim 1, wherein one end of the current control conductor is grounded.

13. A radio communication terminal having two casings movably connected by a connector comprising:
an antenna section disposed in a vicinity of the connector of a casing;
a current control conductor disposed and grounded in the direction opposite to the antenna section of the casing.

14. A radio communication terminal according to claim 13, wherein the current control conductor comprises an L-shaped portion.

15. A radio communication terminal according to claim 13, wherein the current control conductor comprises a meander-shaped portion.

16. A radio communication terminal according to claim 13, wherein the current control conductor comprises a helical-shaped portion.

17. A radio communication terminal according to claim 16, wherein the helical-shaped portion is formed on a surface of an insulator.

18. A radio communication terminal according to claim 13, wherein the current control conductor comprises a portion disposed substantially perpendicular to a substrate in the casing.

19. A radio communication terminal according to claim 18, wherein the portion disposed substantially perpendicular to the substrate comprises a helical shape.

20. A radio communication terminal according to claim 13, wherein a plurality of current control conductors are disposed.
